(19) United States
(12) Patent Application Publication
(10) Pub. No.: US 2014/0146810 A1
(43) Pub. Date: May 29, 2014

(54) MULTI-CHANNEL ACCESS CONTROL METHOD AND APPARATUS FOR AIS BASED ON DULTIPLE TRANSMITTERS

(71) Applicant: Electronics and Telecommunications Research Institute, Daejeon-si (KR)

(72) Inventors: Joa Hyoung LEE, Daejeon (KR); Jin Kyu CHOI, Daejeon (KR); Byung Tae JANG, Daejeon (KR)

(73) Assignee: Electronics and Telecommunications Research Institute, Daejeon-si (KR)

(21) Appl. No.: 14/015,314

(22) Filed: Aug. 30, 2013

(30) Foreign Application Priority Data
Nov. 28, 2012 (KR) 10-2012-0135700

(51) Int. Cl. H04J 3/16

(52) U.S. Cl. CPC H04J 3/1694
USPC 370/348

(57) ABSTRACT

The present invention relates to a method and apparatus in which an Automatic Identification System (AIS) accesses a radio channel. The present invention includes selecting a slot on which a packet is to be transmitted on at least one radio channel, temporarily sending a first carrier, notifying other AISs that the selected slot has been selected by the AIS, on the selected slot in transmission mode, and after temporarily sending the first carrier, detecting a second carrier transmitted by another device on the selected slot in reception mode. In accordance with the present invention, the AIS temporarily sends a first carrier, notifying other AISs that a selected slot has been selected by the AIS, on the selected slot prior to the detection of a second carrier, and another AIS accessing the same slot detects the first carrier temporarily transmitted. Accordingly, a collision between channels can be avoided.

Priority to Korean patent application number 2012-0135700 filed on Nov. 28, 2012, the entire disclosure of which is incorporated by reference herein, is claimed.

### BACKGROUND OF THE INVENTION

1. Field of the Invention

The present invention relates to wireless communication and, more particularly, to a method and apparatus for accessing a radio channel in an automatic identification system.

2. Discussion of the Related Art

An Automatic Identification System (hereinafter referred to as an ‘AIS’) is used for a safe voyage of a vessel. The AIS is a navigation device which enables information, such as the name, dimensions, location, direction of progress, and speed of a vessel, to be automatically transmitted and received between vessels or between a vessel and land through wireless data communication for the voyage safety and security reinforcement of a vessel. The AIS can perform harbor control and wide-area control over coastal waters by providing information about the location of a vessel and can support a search and rescue when a marine accident occurs. The AIS can include two Time Division Multiple Access (TDMA) receivers and one TDMA transmitter. The AIS can send a message according to a TDMA scheme using alternately two Very High Frequency (VHF) channels. For example, the AIS can classify one minute into frames having 2250 slots, allocate 1 to 5 slots to each frame, and send a packet.

The AIS can be basically divided into a Class A type and a Class B type. In the Class A type, medium access schemes, such as Self-Organized Time Division Multiple Access (SOTDMA), Random Access Time Division Multiple Access (RATDMA), and Incremental Time Division multiple Access (ITDMA), are used. In the Class B type, a medium access scheme, such as Collision Sense Time Division Multiple Access (CSTDMA), is used.

In the SOTDMA scheme chiefly used in the Class A type AIS, the AIS checks whether or not another AIS sends a packet, writes a frame map based on a result of the check, searches for a slot in which another AIS does not send a packet, and allocates the retrieved slot, and sends a packet through the allocated slot. The AIS can prevent a collision between packets by periodically sending location information and predicting slots to be used in a next frame based on previously received packets so that unused slots are allocated.

In contrast, in a medium access scheme according to a Class B type AIS, in order to guarantee the priority use of a channel in a medium access scheme according to a Class A type AIS, the CSTDMA scheme is used so that a channel can be accessed only when the channel is not used in the medium access scheme according to an Class A type AIS. In other words, in the CSTDMA scheme used in a Class B type AIS, the AIS performs a channel check, that is, carrier detection, before sending a packet in order to check whether or not another AIS sends a packet and sends the packet when the state of the channel is free, that is, when a carrier is not detected. A case where a carrier is not detected includes a case where a signal level higher than a carrier detection threshold is not detected.

Formerly, in an International Telecommunication Union Radio (ITU-R) communication sector, two VHF channels were allocated for AIS purposes. Recently, four channels are additionally allocated to an AIS, and thus a scheme capable of sending pieces of additional information in addition to location information is being sought. In a current AIS, a primary object of the AIS is to periodically send information about the location of a vessel, and the information occupies most of data. Thus, the AIS can predict an unused slot based on a frame map and efficiently operate in a channel based on SOTDMA without a collision between packets. If common data is aperiodically transmitted in a newly added channel, however, it is difficult to use SOTDMA due to low efficiency of a frame map. Meanwhile, if the CSTMDA scheme is used, an AIS can determine whether slots are used or not by detecting a carrier when sending a packet so that a collision is prevented in a channel (particularly, slot). If a plurality of AISs selects the same slot using the CSTDMA scheme, however, there is a problem in that a collision is generated when the plurality of AISs send packets because a carrier is not detected.

### SUMMARY OF THE INVENTION

An object of the present invention is to provide a channel access control method and apparatus in an AIS.

Another object of the present invention is to provide a method and apparatus for preventing the occurrence of a collision when an AIS accesses a channel using CSTDMA.

Yet another object of the present invention is to provide a method and apparatus for preventing the occurrence of a collision when an AIS aperiodically sending data accesses a channel.

In accordance with an aspect of the present invention, there is provided a channel access method performed by an AIS. The method includes selecting a slot on which a packet is to be transmitted on at least one radio channel, temporarily sending a first carrier, notifying other AISs that the selected slot has been selected by the AIS, on the selected slot in transmission mode, and after temporarily sending the first carrier, detecting a second carrier transmitted by another device on the selected slot in reception mode.

In accordance with another aspect of the present invention, there is provided an AIS. The AIS includes a control module for selecting a slot on which a packet is to be transmitted on at least one radio channel, a TDMA TX module for temporarily sending a first carrier, notifying other AISs that the selected slot has been selected by the AIS, on the selected slot, and a TDMA RX module for detecting a second carrier, transmitted by another device, on the selected slot after the TDMA TX module temporarily sends the first carrier.

### BRIEF DESCRIPTION OF THE DRAWINGS

FIG. 1 shows a channel access method based on SOTDMA in a Class A type AIS;

FIG. 2 shows a channel access method based on CSTDMA in a Class B type AIS;

FIG. 3 shows an example in which collision avoidance is performed when a channel access method based on SOTDMA in a Class A type AIS and a channel access method based on CSTDMA in a Class B type AIS are performed at the same time;

FIG. 4 shows timing at which a packet is transmitted in the case of an AIS1 of the Class A type based on SOTDMA and timing at which a packet is transmitted in the case of an AIS2 of the Class B type based on CSTDMA;

FIG. 5 shows a collision avoidance operation through carrier detection between an AIS1 and an AIS2 of the Class B type based on CSTDMA;

FIG. 6 is a flowchart illustrating a channel access method for preventing a collision between channels in a Class B type AIS based on CSTDMA in accordance with an embodiment of the present invention;

FIG. 7 shows timing at which a Class B type AIS using CSTDMA and performing collision avoidance sends a packet in accordance with an embodiment of the present invention; and

FIG. 8 is a detailed block diagram of an AIS in accordance with an embodiment of the present invention.

### DETAILED DESCRIPTION OF THE EMBODIMENTS

Hereinafter, in this specification, the contents of the present invention will be described in detail in connection with some exemplary embodiments, with reference to the accompanying drawings. It is to be noted that in assigning reference numerals to elements in the drawings, the same reference numerals denote the same elements throughout the drawings even in cases where the elements are shown in different drawings. Furthermore, in describing the embodiments of the present invention, a detailed description of the known functions and constitutions will be omitted if it is deemed to make the gist of the present invention unnecessarily vague.

Furthermore, in describing the elements of this specification, when it is said that one element is ‘connected’, ‘combined’, or ‘coupled’ with the other element, the one element may be directly connected or coupled with the other element, but it should also be understood that a third element may be ‘connected’, ‘combined’, or ‘coupled’ between the two elements.

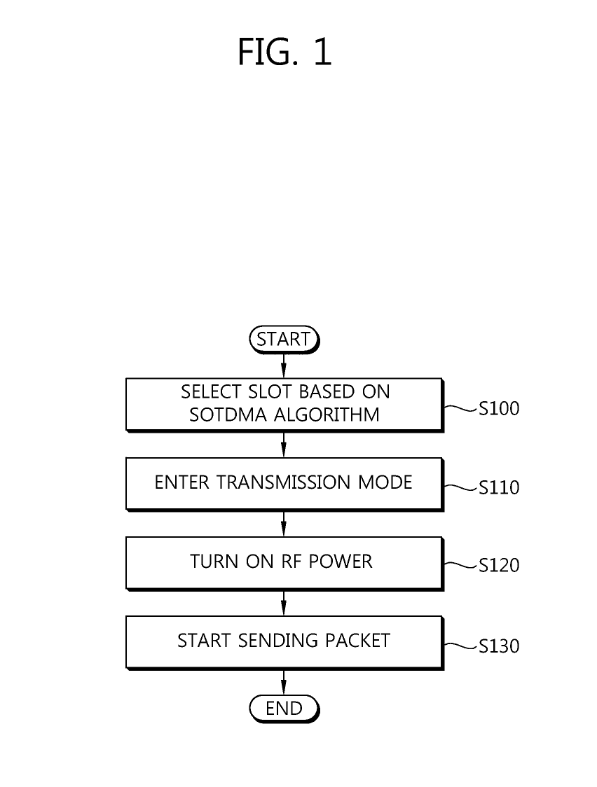

FIG. 1 shows a channel access method based on SOTDMA in a Class A type AIS.

Referring to FIG. 1, in the case where communication is performed based on SOTDMA in the Class A type AIS, if the transmission of a packet is requested or necessary, the AIS selects (or allocates, the same hereinafter) a slot according to an SOTDMA algorithm in order to send the packet at step S100. In this case, the AIS can check a cycle in which another AIS sends a packet, write a frame map based on the cycle, search for a slot on which another AIS does not send a packet, and select the retrieved slot. Next, the AIS enters transmission mode at step S110, turns on Radio Frequency (RF) power at step S120, and sends a packet on the selected slot through RF communication at step S130.

Steps S110 and S120 may be omitted depending on embodiments. For example, the AIS may explicitly enter transmission mode or may directly send the packet on the selected slot without turning on the RF power. This process is performed as follows.

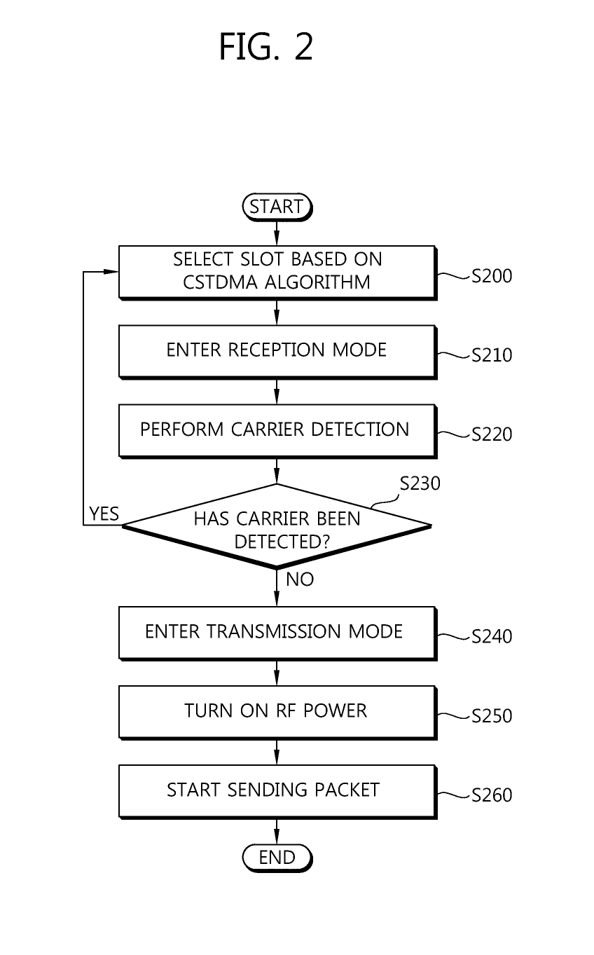

FIG. 2 shows a channel access method based on CSTDMA in a Class B type AIS.

Referring to FIG. 2, if communication is performed based on CSTDMA in a Class B type AIS, the AIS selects a slot according to a CSTDMA algorithm at step S200. Next, the AIS enters reception mode at step S210 and performs carrier detection at step S220. The AIS determines whether the selected slot is used or not based on a result of the carrier detection at step S230. If a signal level greater than a carrier detection threshold is detected in the selected slot, that is, the selected slot is being used, the AIS selects a slot again according to the CSTDMA algorithm at step S200 and repeats the subsequent procedures. If a signal level greater than the carrier detection threshold is not detected in the selected slot, that is, the selected slot is not being used, the AIS enters transmission mode at step S240, turns on RF power at step S250, and sends a packet at step S260. In this case, the AIS allocates the packet to the selected slot and sends the packet. Step S210 may be omitted according to an embodiment. For example, the AIS may directly perform carrier detection without entering reception mode explicitly. This process is performed as follows.

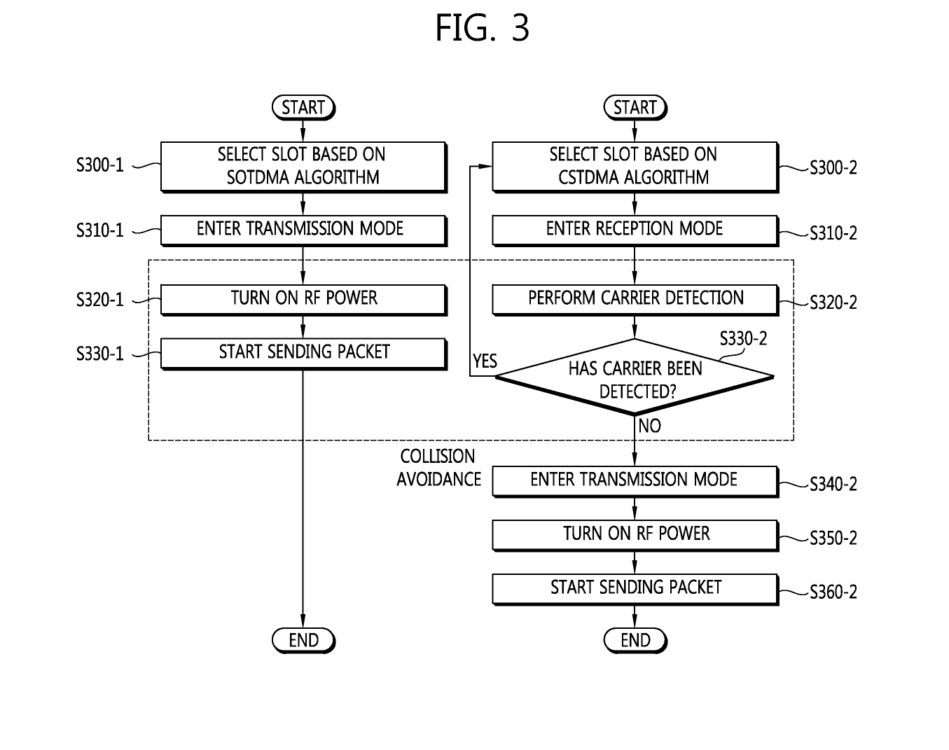

FIG. 3 shows an example in which collision avoidance is performed when a channel access method based on SOTDMA in a Class A type AIS and a channel access method based on CSTDMA in a Class B type AIS are performed at the same time.

Referring to FIG. 3, a detailed operation of an AIS1 of the Class A type based on SOTDMA according to steps S300-1 to S330-1 is the same as the process of steps S100 to S130, and a detailed operation of an AIS2 of the Class B type based on CSTDMA according to steps S300-2 to S360-2 is the same as the process of steps S200 to S260, and thus a detailed description thereof is omitted. The AIS1 turns on RF power at step S320-1 and sends a packet at step S330-1. Thus, if the AIS2 performs carrier detection at step S320-2, the AIS2 detects a carrier transmitted by the AIS1. If a signal level greater than a carrier detection threshold is detected at step S330-2, the AIS2 performs step S300-2, selects another slot according to a CSTDMA algorithm, and then performs steps S310-2 and S330-2 again. As a result, if a carrier having a signal level greater than a carrier detection threshold is not detected, the AIS2 performs steps S340-2 to S360-2. Accordingly, the AIS2 can send a packet to be transmitted without a collision.

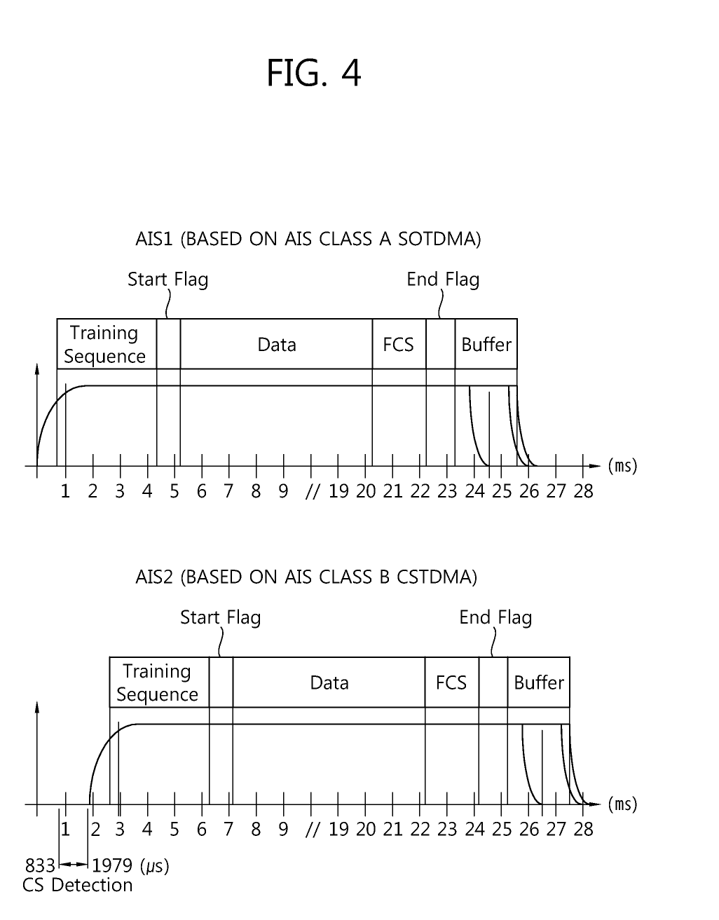

FIG. 4 shows timing at which a packet is transmitted in the case of the AIS1 of the Class A type based on SOTDMA and timing at which a packet is transmitted in the case of the AIS2 of the Class B type based on CSTDMA. In FIG. 4, a unit in a horizontal axis indicates ‘ms’.

Referring to FIG. 4, the AIS1 using SOTDMA turns on the RF power and starts transmission right after a slot is selected. In contrast, the AIS2 using CSTDMA performs carrier detection in reception mode, for example, from 833 μs to 1979 μs after selecting a slot and then (only when a signal level greater than a carrier detection threshold is not detected) turns on the RF power and starts transmission. Accordingly, if the AIS1 using SOTDMA and the AIS2 using CSTDMA attempt to send packets through the same slot at the same time, the AIS1 is already sending a carrier when the AIS2 performs carrier detection. As a result, the AIS2 can detect the carrier without a collision.

Formerly, in an ITU-R communication sector, two VHF channels were allocated for AIS purposes. Recently, four channels are additionally allocated to an AIS, and thus a scheme capable of sending pieces of additional information in addition to location information is being sought. Two of the additional four channels are expected to be used for satellite detection, and the remaining two of the additional four channels are expected to be used for the exchange of common data between vessels. In an existing AIS, two receivers and one transmitter are used in order to use two VHF channels. In order to efficiently use the additional four channels, an AIS needs to be improved to have a minimum of two transmitters, and a channel access scheme for efficiently using a plurality of channels using a plurality of transmitters is necessary. In particular, when an AIS sends common data in a specific time zone, there is a good possibility that a collision between packets can occur in any one channel (particularly, a slot). Accordingly, a method for preventing or avoiding the collision is necessary.

In a current AIS, a primary object of the AIS is to periodically send information about the location of a vessel, and the information occupies most of data. Accordingly, an AIS based on SOTDMA in which an unused slot is detected based on a frame map and used can efficiently operate in a channel without a collision between packets. If common data is aperiodically transmitted in a newly added channel, however, it is difficult to use SOTDMA because efficiency of a frame map is low. Meanwhile, if the CSTMDA scheme is used, an AIS can determine whether slots are used or not by detecting a carrier when sending a packet so that a collision is prevented in a channel (particularly, slot). If a plurality of AISs uses CSTDMA and selects the same slot, however, a problem in that a carrier is not detected in a carrier detection step can occur.

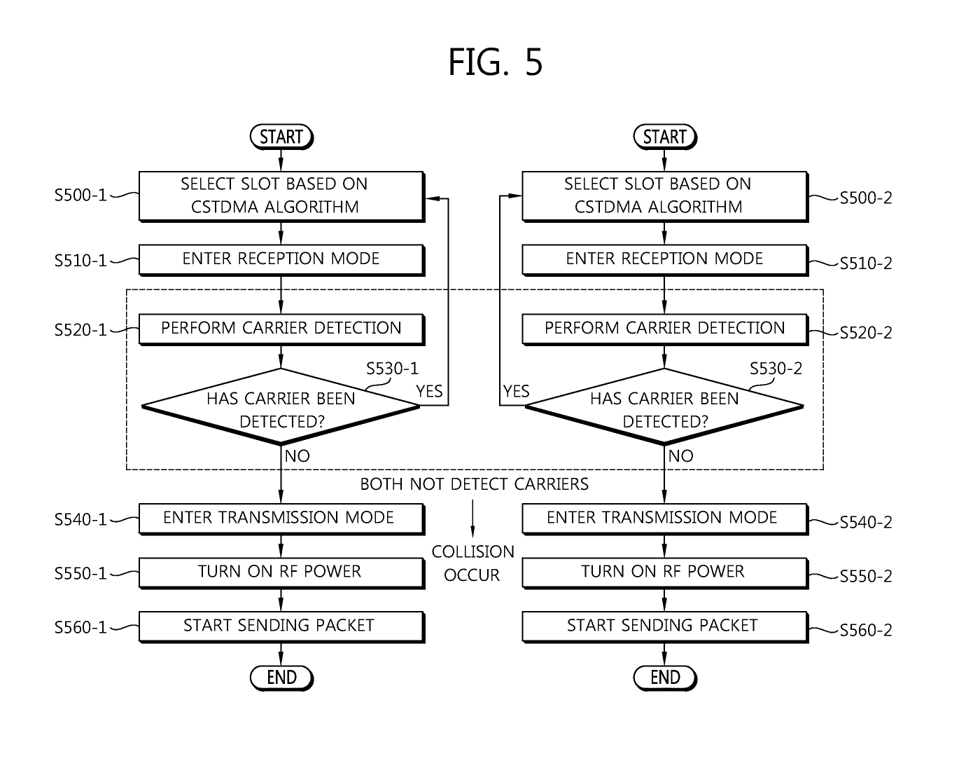

FIG. 5 shows a collision avoidance operation through carrier detection between an AIS1 and an AIS2 of the Class B type based on CSTDMA. FIG. 5 shows a problem of collision avoidance through carrier detection when both the AIS1 and the AIS2 use CSTDMA.

Referring to FIG. 5, a detailed operation of steps S500-1 to S560-1 performed by the AIS1 and a detailed operation of steps S500-2 to S560-2 performed by the AIS are the same as the process of steps S200 to S260 shown in FIG. 2, and thus a detailed description thereof is omitted. If both the AIS1 and the AIS2 use CSTDMA, use the same slot allocated thereto, and send packets at the same time, the AIS1 and the AIS2 enter reception mode at the same time or at a similar time at steps S510-1 and S510-2 and wait in order to detect carriers at steps S520-1 and S520-2. In this case, a signal level greater than a carrier detection threshold is not detected because both the AIS1 and the AIS2 are in standby state in reception mode. Thus, results of the carrier detection at steps S530-1 and S530-2 are commonly “No”. As a result, there is a problem in that a collision is generated because the AIS1 and the AIS2 send the packets through the same slot at steps S540-1 to S560-1 and steps S540-2 to S560-2.

In order to solve the above problem, a method and apparatus for preventing a collision when an AIS accesses a channel using CSTDMA according to the present invention are described below.

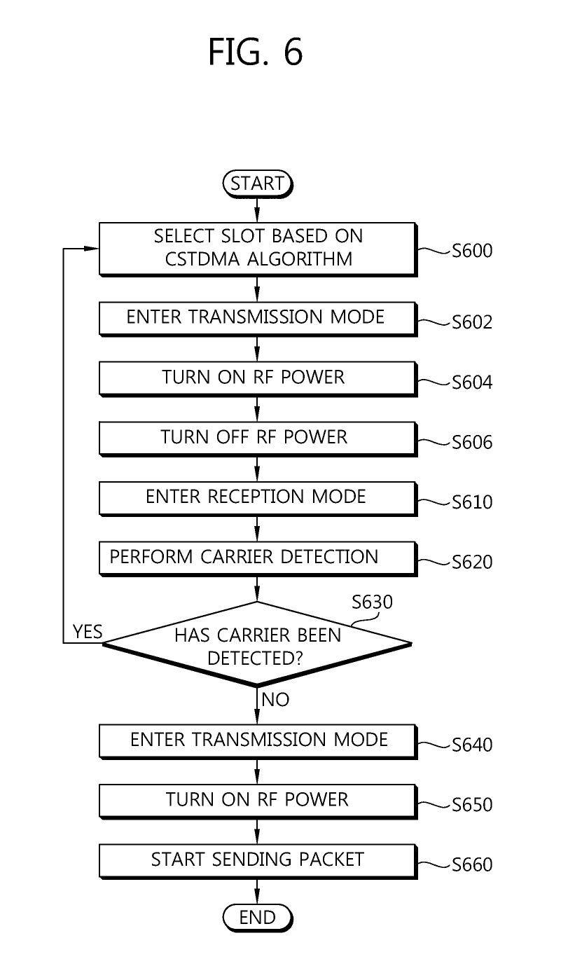

FIG. 6 is a flowchart illustrating a channel access method for preventing a collision between channels in a Class B type AIS based on CSTDMA in accordance with an embodiment of the present invention.

Referring to FIG. 6, the AIS selects a slot on which a packet will be transmitted on at least one radio channel at step S600. The AIS can select a slot on which a packet will be transmitted according to a CSTDMA algorithm.

Next, the AIS enters transmission mode at step S602, turns on RF power at step S604, temporarily sends a first carrier, notifying other AISs that the selected slot has been selected by the AIS, on the selected slot, and then turns off the RF power at step S606. In this case, another AIS can detect the first carrier when another AIS using CSTDMA accesses the same slot. That is, in accordance with the present invention, although CSTDMA is used, an AIS can enter transmission mode without entering reception mode after selecting a slot and temporarily send a first carrier in order to notify other AISs that the slot is being used.

In this case, the first carrier may carry a predetermined and specific flag packet (or signal) indicating that the slot is being used or may carry a null packet (or signal). To send the first carrier temporarily may include that the RF power is turned on and the first carrier is transmitted for a predetermined time or may include that the first carrier is transmitted through an impulse signal.

Next, the AIS enters reception mode at step S610 and detects a second carrier transmitted by another device on the selected slot in reception mode at step S620. The AIS determines whether or not the second carrier has been detected at step S630. If, as a result of the determination at step S630, a signal level greater than a carrier detection threshold is detected, the AIS repeats the steps following step S600. In this case, the AIS can select (or reselect) another slot according to the CSTDMA algorithm.

If, as a result of the determination at step S630, a signal level greater than a carrier detection threshold is not detected, the AIS enters transmission mode at step S640, turns on the RF power at step S650, and starts sending a packet at step S660. In this case, the AIS can allocate the packet to the selected slot and send the packet.

Some of steps S602, S604, S606, S610, S640, and S650 may be omitted depending on an embodiment of the present invention. For example, the AIS may enter transmission mode explicitly, may send the first carrier temporarily without turning on the RF power, or may perform carrier detection directly without entering reception mode explicitly. For another example, the AIS may send the packet on the selected slot without entering transmission mode explicitly or turning on the RF power.

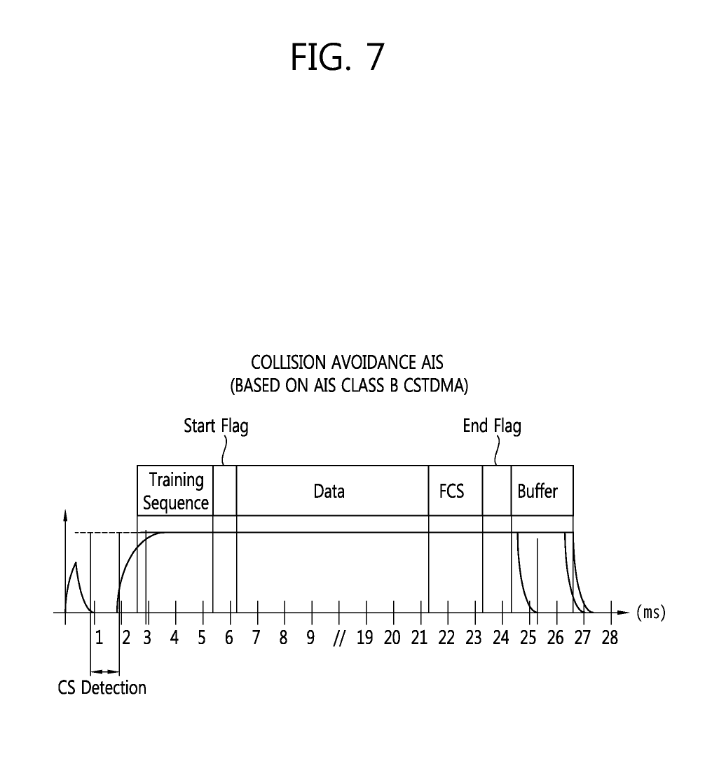

FIG. 7 shows timing at which a Class B type AIS using CSTDMA and performing collision avoidance sends a packet in accordance with an embodiment of the present invention. In FIG. 7, a unit in a horizontal axis is ‘ms’.

Referring to FIG. 7, the AIS according to the present invention selects the slot, turns on the RF power in transmission mode, temporarily sends the first carrier, and then turns off the RF power. Next, the AIS enters reception mode and detects the second carrier. That is, the AIS temporarily sends the first carrier prior to the detection of the second carrier. In this case, a collision between channels (particularly, slots) can be avoided because another AIS accessing the same slot can detect the first carrier temporarily transmitted.

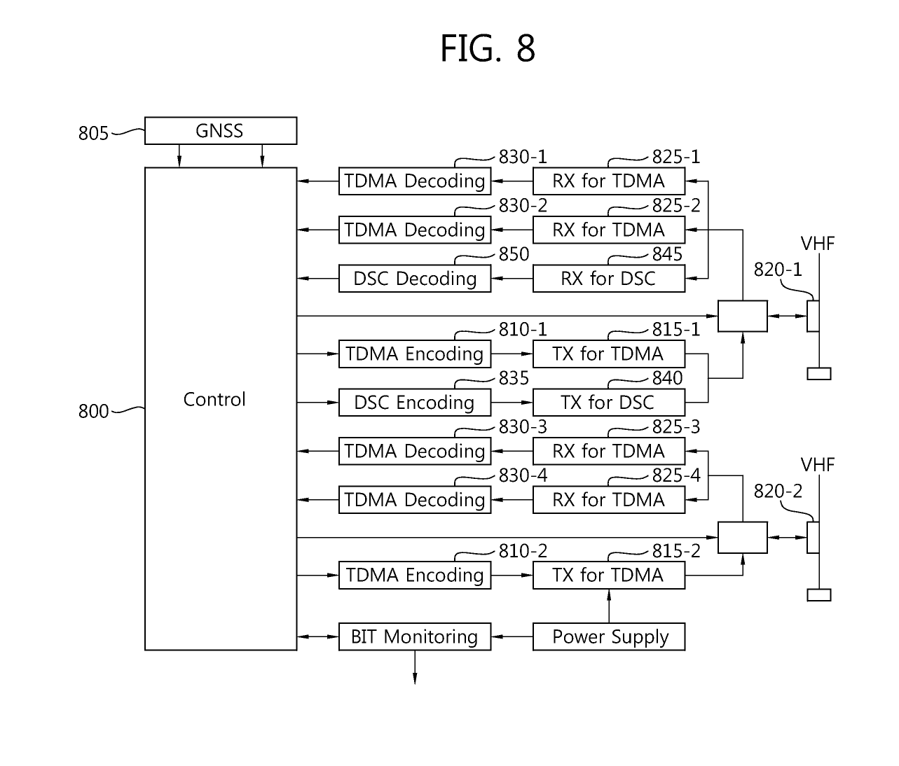

FIG. 8 is a detailed block diagram of an AIS in accordance with an embodiment of the present invention. In the present embodiment, the AIS includes two VHF antenna modules in order to operate in six VHF channels. It is assumed that each of the VHF antenna modules includes two TDMA receiver (RX) modules and one TDMA transmitter (TX) module for transmission and reception and a TDMA encoding module and a TDMA decoding module for a TDMA message. It is to be noted that the number of channels, the number of antenna modules, and the number of RX modules and RX modules forming the antenna module are illustrative. The AIS may operate in a channel other than a VHF, may operate in a larger or smaller number of channels, and may include a larger or smaller number of antenna modules, and one antenna module may include a larger or smaller number of TDMA TX modules or TDMA RX modules without departing from an intrinsic characteristic of the present invention.

Referring to FIG. 8, the AIS includes a control module 800, a Global Navigation Satellite System (GNSS) module 805, TDMA encoding modules 810-1 and 810-2, TDMA TX modules 815-1 and 815-2, antenna modules 820-1 and 820-2, TDMA RX modules 825-1, 825-2, 825-3, and 825-4, TDMA decoding modules 830-1, 830-2, 830-3, and 830-4, a Digital Selective Calling (DSC) encoding module 835, a DSC TX module 840, a DSC RX module 845, and a DSC decoding module 850.

The control module 800 controls the modules forming the AIS. The GNSS module 605 receives information about the location and time of the AIS (or a vessel equipped with the AIS) from satellites and transfers the information to the control module 800.

The TDMA encoding modules 810-1 and 810-2 receive messages from the control module 800 and produce the messages into TDMA message by encoding the received message. The TDMA TX modules 815-1 and 815-2 receive the TDMA messages from the TDMA encoding modules 810-1 and 810-2, perform radio signal processing on the TDMA messages, and send the processing results through the antenna modules 820-1 and 820-2.

The antenna modules 820-1 and 820-2 can send and receive signals having a VHF band.

The TDMA RX modules 825-1, 825-2, 825-3, and 825-4 receive TDMA messages from the outside through the antenna modules 820-1 and 820-2. The TDMA decoding modules 830-1, 830-2, 830-3, and 830-4 decode the TDMA messages received by the TDMA RX modules 825-1, 825-2, 825-3, and 825-4.

The DSC encoding module 835 encodes a DSC message. DSC is a standard regarding the sending of a pre-defined digital message, and a distress signal, etc. can be transmitted rapidly in accordance with the DSC standard.

The DSC TX module 840 performs radio signal processing on the encoded DSC message and sends the processing result. The DSC RX module 845 receives a DSC message from the outside. The DSC decoding module 850 decodes the received DSC message.

The TDMA RX modules 825-1 825-2, 825-3, and 825-4 can operate in different channels, and at least one of the TDMA TX modules 815-1 and 815-2 can access a channel using the channel access method described with reference to FIG. 6 and send a packet. For example, the TDMA TX module 815-1 can access a channel using the channel access method described with reference to FIG. 2, and the TDMA TX module 815-2 can access a channel using the channel access method described with reference to FIG. 2.

More particularly, the control module 800 selects a slot on which a packet will be transmitted on at least one radio channel. The control module 800 may select the slot according to a CSTDMA algorithm. The TDMA TX module 815-2 temporarily sends a first carrier, notifying other AISs that the slot has been selected by the AIS, on the selected slot. After the TDMA TX module 815-2 temporarily sends the first carrier, the TDMA RX module 825-4 detects a second carrier transmitted by another device on the selected slot. The control module 800 may perform control so that the TDMA TX module 815-2 temporarily sends the first carrier notifying other AISs that the slot has been selected by the AIS and perform control so that the TDMA RX module 825-4 detects the second carrier transmitted by another device.

The control module 800 determines whether or not the intensity of the second carrier detected on the slot is greater than a threshold (or carrier detection threshold). If, as a result of the determination, the intensity of the second carrier is smaller than the carrier detection threshold, the TDMA TX module 815-2 can send a packet on the slot. The control module 800 can perform control so that the TDMA TX module 815-2 sends the packet on the slot when the intensity of the second carrier is smaller than the carrier detection threshold.

Meanwhile, if, as a result of the determination, the intensity of the second carrier is greater than the carrier detection threshold, the control module 800 can reselect a slot on which the packet will be transmitted. In this case, the control module 800 can select the slot according to the CSTDMA algorithm. The TDMA TX module 815-2 can temporarily send a third carrier, notifying other AISs that the reselected slot has been selected by the AIS, on the reselected slot. After the TDMA TX module 815-2 temporarily sends the third carrier, the TDMA RX module 825-4 can detect a fourth carrier transmitted by another device on the reselected slot. The control module 800 can perform control so that the TDMA TX module 815-2 temporarily sends the third carrier notifying other AISs that the reselected slot has been selected by the AIS and then perform control so that the TDMA RX module 825-4 detects the fourth carrier transmitted by another device.

Next, the control module 800 determines whether or not the intensity of the fourth carrier detected on the reselected slot is greater than a carrier detection threshold. If, as a result of the determination, the intensity of the fourth carrier is smaller than the carrier detection threshold, the TDMA TX module 815-2 can send a packet on the reselected slot. The control module 800 can perform control so that the TDMA TX module 815-2 sends the packet on the reselected slot when the intensity of the fourth carrier is smaller than the carrier detection threshold.

In accordance with the present invention, if the AIS uses a channel access method based on CSTDMA, the AIS temporarily sends a carrier, notifying other AISs that a selected slot has been selected by the AIS, on the selected slot prior to carrier detection, and another AIS accessing the same slot detects the temporarily transmitted carrier. Accordingly, a collision between channels, particularly, slots can be avoided.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the following appended claims. Accordingly, the present invention should be construed as covering all modifications or variations derived from the meaning and scope of the appended claims and their equivalents.

What is claimed is:

1. A channel access method performed by an Automatic Identification System (AIS), comprising:
selecting a slot on which a packet is to be transmitted on at least one radio channel;
temporarily sending a first carrier, notifying other AISs that the selected slot has been selected by the AIS, on the selected slot in transmission mode; and
after temporarily sending the first carrier, detecting a second carrier transmitted by another device on the selected slot in reception mode.

2. The channel access method of claim 1, further comprising:
if a signal level greater than a carrier detection threshold is not detected in detecting the second carrier, sending the packet on the selected slot, and
if a signal level greater than the carrier detection threshold is detected in detecting the second carrier, reselecting another slot, temporarily sending a third carrier, notifying other AISs that the reselected slot has been selected by the AIS, on the reselected slot in transmission mode, and detecting a fourth carrier transmitted by another device on the reselected slot in reception mode.

3. The channel access method of claim 2, wherein the AIS operates based on Collision Sense time Division Multiple Access (CSTDMA).

4. The channel access method of claim 3, wherein the slot is selected according to a CSTDMA algorithm.

5. An Automatic Identification System (AIS), comprising:
a control module for selecting a slot on which a packet is to be transmitted on at least one radio channel;
a TDMA TX module for temporarily sending a first carrier, notifying other AISs that the selected slot has been selected by the AIS, on the selected slot; and
a TDMA RX module for detecting a second carrier, transmitted by another device, on the selected slot after the TDMA TX module temporarily sends the first carrier.

6. The AIS of claim 5, wherein:
the control module determines whether or not an intensity of the second carrier detected on the slot is greater than a threshold, and
the TDMA TX module sends the packet on the slot if, as a result of the determination, the intensity of the second carrier is smaller than the threshold.

7. The AIS of claim 5, wherein:
the control module determines whether or not an intensity of the second carrier detected on the slot is greater than a threshold, and
the control module reselects a slot on which the packet is to be transmitted if, as a result of the determination, the intensity of the second carrier is greater than the threshold.

8. The AIS of claim 7, wherein:
the TDMA TX module temporarily sends a third carrier, notifying other AISs that the reselected slot has been selected by the AIS, on the reselected slot, and
the TDMA RX module detects a fourth carrier, transmitted by another device, on the reselected slot after the TDMA TX module temporarily sends the third carrier.

9. The AIS of claim 8, wherein:
the control module determines whether or not an intensity of the fourth carrier detected on the slot is greater than a threshold, and
the TDMA TX module sends the packet on the reselected slot if, as a result of the determination, the intensity of the fourth carrier is smaller than the threshold.

10. The AIS of claim 5, wherein the control module selects or reselects the slot according to a CSTDMA algorithm.
